(19) United States
(12) Patent Application Publication
(10) Pub. No.: US 2010/0288055 A1
(43) Pub. Date: Nov. 18, 2010

(54) TRANSIT TIME CORRECTION IN A FLOW SENSOR

(76) Inventors: Roland Mueller, Steinheim (DE); Gerhard Hueftle, Aspach (DE); Dirk Daecke, Stuttgart (DE); Bernhard Opitz, Leonberg (DE); Michael Horstbrink, Stuttgart-Feuerbach (DE); Frank Steuber, Korntal-Muenchigen (DE); Tobias Lang, Stuttgart (DE); Sami Radwan, Stuttgart (DE); Bernd Kuenzl, Schwieberdingen (DE); Roland Wanja, Markgroeningen (DE); Ralf Kieser, Korntal (DE)

Correspondence Address: MICHAEL J. STRIKER, 103 EAST NECK ROAD, HUNTINGTON, NY, 11743, US

(21) Appl. No.: 12/775,707

(22) Filed: May 7, 2010

(30) Foreign Application Priority Data
May 12, 2009 (DE) 10 2009 003 020.4

(51) Int. Cl. G01F 1/66

(52) U.S. Cl. 73/861.28

(57) ABSTRACT

A sensor measures a flow quantity of a medium using a first wave converter and a second wave converter which faces the first wave converter, each of which emits and receives sound waves, and a device calculates the flow quantity on the basis of a first wave transit time from the first wave converter to the second wave converter, and on the basis of a second wave transit time from the second wave converter to the first wave converter. The device includes a unit for limiting the change to the flow quantity. In this manner, and the measurement may be carried out more accurately.

### CROSS-REFERENCE TO RELATED APPLICATION

The invention described and claimed hereinbelow is also described in German Patent Application DE 10 2009 003 020.4 filed on May 12, 2009. This German Patent Application, whose subject matter is incorporated here by reference, provides the basis for a claim of priority of invention under 35 U.S.C. 119(a)-(d).

### BACKGROUND OF THE INVENTION

The present invention relates to a sensor for measuring a flow quantity of a medium, such as the flow velocity or the mass flow, and to a method for measuring the flow of a medium.

Ultrasonic flow sensors are used, e.g., to measure the volumetric flow, mass flow, or flow velocity of a gaseous or liquid medium that flows through a pipeline. A known type of ultrasonic flow sensor includes two ultrasonic converters located such that they are offset in the direction of flow, each of which generates ultrasonic signals and transmits them to the other ultrasonic converter. The ultrasonic signals are received by the other converter and are evaluated electronically. The difference between the transit time of the signal in the direction of flow and the transit time of the signal in the opposite direction is a measure of the flow velocity of the fluid.

FIG. 1 shows a typical design of an ultrasonic flow sensor 6 that includes two ultrasonic converters 4, 5, which are located inside a pipeline 3 and are diametrically opposed at a distance L from each other. A fluid 1 flows in pipeline 3 at a velocity v in the direction of arrow 2. Measurement path L is tilted relative to flow direction 2 at an angle α. Converters 4, 5 are offset relative to one another in the direction of flow. While a measurement is being performed, ultrasonic converters 4, 5 send ultrasonic pulses to each other, which are slowed or accelerated depending on the direction of the flow. The transit times of the ultrasonic signals are a measure of the flow velocity to be determined.

FIG. 2 shows a greatly simplified schematic depiction of the system which includes an associated transmitting and receiving circuit 7. Ultrasonic converters 4, 5 are activated by an oscillator using a signal 8 that has a specified clock frequency (e.g., a square-wave signal). Ultrasonic signals 10 that are generated as a result (only the envelopes of the signals are shown here) travel along measurement path L and are detected by the other ultrasonic converter 4, 5. On the basis of sensor signals S1, S2, transmitting and receiving circuit 7 determines transit time t₁ and t₂ of ultrasonic signals 10. Finally, a downstream computation unit 15 calculates, on the basis of each value pair t₁,t₂, the desired flow quantity, such as the flow velocity of the medium. Circuits 7 and 15 together form an evaluation unit 16.

Typically, sound waves 10 are dampened and distorted to a great extent as they travel through the medium. This applies, in particular, for signal t₂ that travels against the direction of flow. It is therefore relatively difficult to exactly determine the reception time at one of the sensors 4, 5, and therefore the individual measured values of wave transit times t₁ and, in particular, t₂, may fluctuate to a great extent. This ultimately results in an inaccurate determination of the flow quantity which is calculated on the basis of wave transit times t₁ and t₂.

### SUMMARY OF THE INVENTION

The object of the present invention, therefore, is to provide a sensor and a method for measuring the flow of a medium, using which a flow quantity of the medium may be determined more exactly and reliably.

According to the present invention, a device is provided that calculates a desired flow quantity on the basis of the sensor signals of the wave converter, the device including means for limiting the change of the flow quantity. These means are preferably designed such that they account for transit times of the sound signals (e.g., a plurality of values of t₁ and/or t₂) measured at a plurality of instants and, based thereon, determine a value, such as a modified wave transit time (e.g., t₁′ or t₂′) or a quantity that is dependent thereon (e.g., a sound velocity c that is calculated on the basis of the transit times), that fluctuates to a lesser extent than the transit time values that were measured originally. In this manner, the flow quantity that is calculated on the basis of the wave transit times may be determined in a substantially more accurate manner.

The expression “flow quantity” is understood to mean, in particular, a volumetric flow or mass flow, or the flow velocity of a gaseous or liquid medium. The present invention may also be used to calculate other flow quantities.

According to a first embodiment of the present invention, the device includes means that limit the change or fluctuation of at least one of the wave transit times t₁, t₂. Since typically only wave transit time t₂ of the sound signal that travels against the direction of flow is critical, it is sufficient to provide the means only for this wave transit time or for a quantity calculated on the basis thereof. Using the aforementioned means, it is possible to eliminate “outliers” in wave transit time t₁, t₂. As a result, the flow quantity may be calculated more exactly.

The aforementioned means for limiting the change or fluctuation of at least one of the wave transit times may include, e.g., a low-pass filter, which is used to filter a plurality of currently determined wave transit times, e.g., a plurality of transit time values t₂. As a result of the filtering, “outliers” are attenuated. As an alternative, the aforementioned means could also include an interpolation unit that interpolates a plurality of measured values of a wave transit time. New measured values that lie too far outside of the approximating function, which is obtained via the interpolation, may be placed, e.g., on the approximating function or in its vicinity. The fluctuation of the transmit time values (t₁ and/or t₂) is limited as a result. The limited values are then used, in turn, to calculate the desired flow quantity.

According to a second embodiment of the present invention, the change of the wave transit times itself is not limited, but rather the change to a quantity that was calculated on the basis of at wave transit time, such as sound velocity c, total transit time t₁+t₂, or the fluid temperature. To this end, in turn, a filter or an interpolation unit may be provided that limits the change of this quantity. The two embodiments may also be combined.

Instead of the aforementioned low-pass or interpolation, the change to the particular quantity (e.g., t or c) may also be limited to a fixedly specified maximum value. If, e.g., the difference between a first value and a second value of sound velocity c is greater than the specified maximum value, the second value may be limited to the first value plus or minus the maximum value. Therefore, the quantity under consideration does not fluctuate to an extent that is greater than the specified maximum value. “Outliers” are therefore attenuated. However, if two values measured at different instants, e.g., two wave transit times t2₁,t2₂, are close to each other, the more recent value may also be used unfiltered in the remaining calculation.

According to the present invention, it is provided that the aforementioned signal processing may also be switched off if the quality of the two measured transit times allows this, i.e., if the amplitude, in particular, of sound signal t2 that travels against the direction of flow exceeds a specified value.

In order to obtain current values for the flow of the medium as often as possible, the wave transit time that has the higher quality may be measured more frequently than the other wave transit time. In order to increase the robustness of the weaker measurement direction, the wave transit time having the lesser quality may also be measured more frequently, depending on the requirements of the measurement environment.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic view of the ultrasonic converter of an ultrasonic sensor on a pipeline through which air flows;

FIG. 2 shows a schematic view of an ultrasonic sensor, including an associated evaluation device;

FIG. 3 shows a schematic view of a computation unit according to a first embodiment of the present invention;

FIG. 4 shows a schematic view of a computation unit according to a second embodiment of the present invention.

### DESCRIPTION OF THE PREFERRED EMBODIMENTS

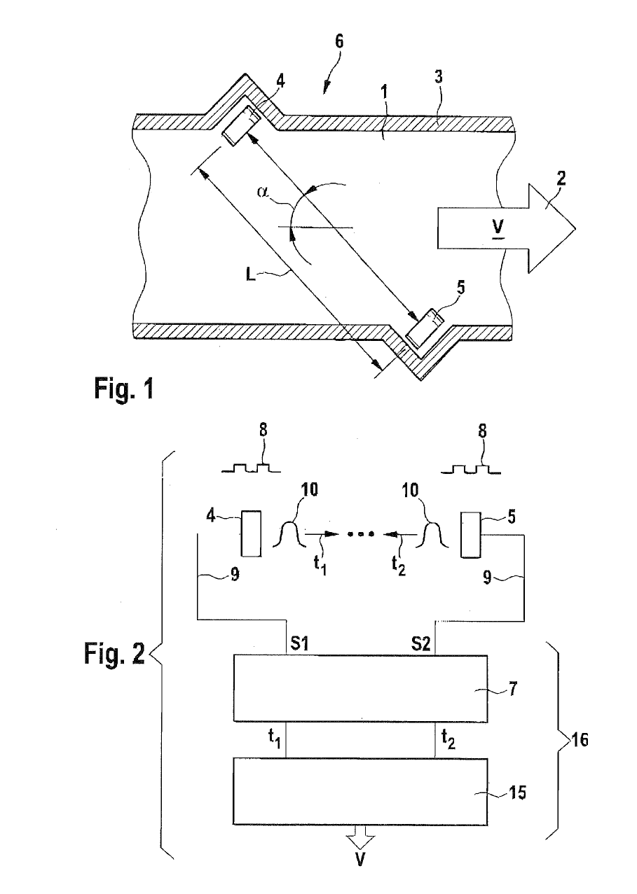

FIGS. 1 and 2 are explained in the introduction to the description.

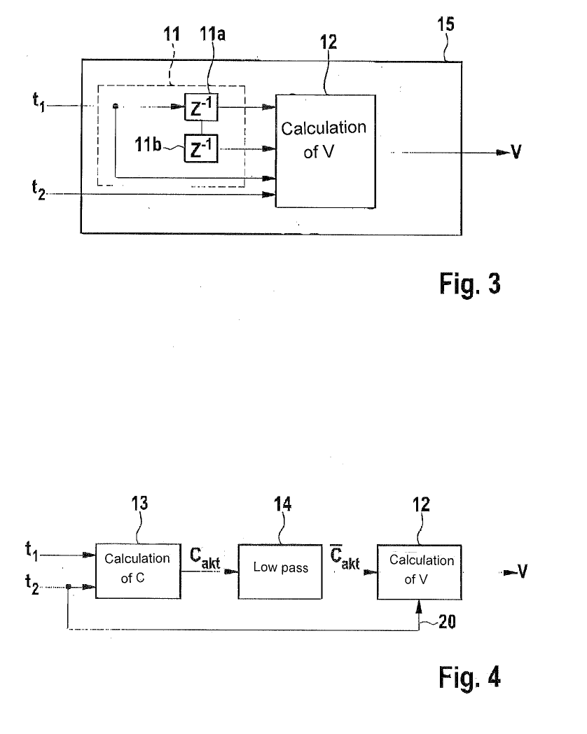

FIG. 3 shows a schematic view of a computation unit 15 according to a first embodiment of the present invention. In this case, computation unit 15 includes an interpolation unit 11 and a circuit or software 12 (referred to hereinbelow as unit 12). Interpolation unit 11 includes, in turn, a plurality of time-delay units 11a,b, which temporarily stores a series of consecutive transit time values t2. Unit 12 includes a filter, such as an FIR filter, that generates a new interpolated value out of all transit time values t2 that are available. This new value is ultimately used to calculate the flow quantity, e.g., the flow velocity.

As shown in FIG. 3, only that input of computation unit 15 at which transit times t2 are present includes an interpolation unit 11 since the associated sound signals are dampened and distorted to a substantially greater extent than the sound signals in the direction of flow. The other branch, at which transit times t1 are present, does not include an interpolation unit 11.

As an alternative, calculation unit 15 could also be programmed in a manner such that it limits the change in transit time t2 to a fixedly specified maximum value. If, e.g., the difference between a first value and a second value of the transit time is greater than the specified maximum value, the second transit time value may be limited to the first value plus or minus the maximum value. Therefore, the transit time does not fluctuate to an extent that is greater than the specified maximum value.

According to an alternative embodiment, interpolation unit 11 could also be replaced by a low-pass filter. The variance of the transit time signal is likewise reduced as a result. Value t₁ and filtered value t₂ are ultimately used to calculate the flow velocity.

FIG. 4 shows a schematic view of a computation unit 15 according to a second embodiment of the present invention. In this case, it is not wave transit times t₂ that are limited, but rather the change in a variable that is calculated on the basis of wave transit times t₁,t₂, such as sound velocity c or a total transit time. A unit 13 is provided for this purpose. The following applies, approximately, for sound velocity c:

$${c}_{akt} = L \frac{{t}_{1} + {t}_{2}}{2 \cdot {t}_{1} \cdot {t}_{2}} \qquad ( 1 )$$

L stands for the length of the path between converters 4, 5. Current sound speed Cₐₖₜ which is determined in this manner is then filtered using a low-pass filter 14, thereby reducing individual extreme values. Finally, on the basis of interpolated value C̅ₐₖₜ and transmit time t₁, it is possible to calculate flow velocity v of the medium using equation (2):

$$v = \frac{\frac{L}{{t}_{1}} - {c}_{akt}}{s} \qquad ( 2 )$$

The value s stands for a geometry-dependent constant for the sensor.

Sound speed c does not need to be continually recalculated since it is assumed that it changes very slowly. Instead, it may be considered to be constant over a certain period of time. To determine flow velocity v, it is therefore only necessary to measure sound transit time t1. As a result, a relatively high rate of repetition of the measurement with high accuracy may be attained.

Since calculating and filtering the sound velocity takes a relatively great deal of time, it may be provided that it is possible to switch to a conventional measurement procedure. In this case, the flow velocity is calculated simply on the basis of a pair of measured values t1, t2.

In a typical application of the present invention, ultrasonic converters 4, 5 are situated, e.g., on a pipeline 3 of the induction tract of an internal combustion engine. An electronic control unit (not depicted) determines sound transit times t₁,t₂ and, based thereon, calculates flow velocity v. Based thereon, in turn, the mass flow of the intake air may be calculated. The electronic control unit may therefore estimate the quantity of oxygen present in the combustion chamber and control an injection valve accordingly, in order to inject the optimal quantity of fuel into the combustion chamber.

It will be understood that each of the elements described above, or two or more together, may also find a useful application in other types of constructions and methods differing from the types described above.

While the invention has been illustrated and described as embodied in a transit time correction in a flow sensor, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A sensor for measuring a flow quantity of a medium, comprising a first wave converter and a second wave converter, each emitting and receiving sound waves; and a device calculating a flow quantify on a basis of a first wave transit time from the first wave converter to the second wave converter, and on a basis of a second wave transit time from the second wave converter to the first wave converter, wherein the device includes means for limiting a change in the flow quantity.

2. The sensor as defined in claim 1, wherein said means limit a parameter selected from the group consisting of a change of one of the wave transit times and a quantity calculated on a basis thereof.

3. The sensor as defined in claim 1, wherein said means includes an element selected from the group consisting of an interpolation unit and a filter.

4. The sensor as defined in claim 1, wherein the means limit the flow quantity selected from the group consisting of a mass flow and a flow velocity.

5. The sensor as defined in claim 2, wherein a change-limited quantity is a total transit time composed of both wave transit times, a fluid temperature, or a sound velocity of the waves in the medium.

6. The sensor as defined in claim 1, wherein said means exclusively limits a parameter selected from the group consisting of a wave transit time of a sound signal that travels against a direction of flow of the medium, and a quantity that is calculated on a basis of said wave transit time of the sound signal.

7. The sensor as defined in claim 1, wherein said means for limiting the change in the flow quantity is switchable off means.

8. The sensor as defined in claim 1, wherein said device measures one of the two wave transit times at a higher rate of repetition than the other of the two wave transit times.

9. The sensor as defined in claim 8, wherein the rate of repetition of the measurement is higher than the wave transit time having a higher quality.

10. A method for measuring a flow quantity of a medium, comprising the steps of using a first wave converter and a second wave converter each emitting and receiving sound waves; calculating a flow quantity on a basis of a first wave transmit time from the first wave converter to the second wave converter, and on a basis of a second wave transit time from the second wave converter to the first wave converter; and limiting a change in a flow quantity.

11. A method as defined in claim 10, wherein said limiting includes limiting a change of a parameter selected from the group consisting of at least one of the wave transit times and a variable that is calculated on a basis thereof.

12. A method as defined in claim 11, wherein said calculating includes calculating the flow quantity on a basis of a parameter selected from the group consisting of a limited wave transit time and a limited quantity.

13. A method as defined in claim 10, wherein said second wave converter faces said first wave converter.
